(19) United States
(12) Patent Application Publication
(10) Pub. No.: US 2026/0289718 A1
(43) Pub. Date: Sep. 24, 2026

(54) DIGITAL WATERMARKING OF VIDEOS

(71) Applicant: Logistics and Supply Chain MultiTech R&D Centre Limited, Pok Fu Lam (HK)

(72) Inventors: Chun Fai Chan, Pok Fu Lam (HK); Wan Kit Yip, Pok Fu Lam (HK); Aysan Esmradi, Pok Fu Lam (HK); Chung Dak Shum, Pok Fu Lam (HK)

(21) Appl. No.: 19/088,058

(22) Filed: Mar. 24, 2025

(51) Int. Cl. G06T 1/00; G10L 19/018; H04L 9/32

(52) U.S. Cl. CPC G06T 1/005; G10L 19/018; H04L 9/3226; G06T 2201/0065; H04L 2209/608

(57) ABSTRACT

A computer-implemented method for generating an authentic video including receiving a genuine video, the video including an audio track and a visual track, separating the genuine video into an audio track and a visual track, embedding a first digital watermark in the visual track, embedding a second digital watermark in the audio track, wherein the first digital watermark is based on a first indicator associated with authentic visual data, wherein the second digital watermark is based on a second indicator associated with authentic audio data.

### TECHNICAL FIELD

The present invention relates to a system and method for generating an authentic video by applying a digital watermark.

### BACKGROUND

Videos have become very popular especially with advent of smartphones and social media. Videos are commonly shared across various social media sites as well as video streaming sites such as YouTube and other similar sites.

There has also been a rise in fake videos. The increase in fake videos has increased due to the rise in AI. Deep fakes and other AI based fakes are becoming more prevalent. Besides fake videos, copying of videos has always been an issue especially due to the monetisation of social media. Stealing of video content has become increasingly common. Therefore, it can be challenging to determine if a video is an authentic video i.e., an original video.

### SUMMARY OF THE INVENTION

The present invention relates to a system and method for generating an authentic video by applying a digital watermark. The present invention a validation process to validate a video is authentic based on an applied digital watermark. The system and method for generating an authentic video may apply a separate digital watermarks to visual data and audio data in a video.

The systems and/or methods described herein seek to provide a process for generating an authentic video by applying a digital watermark which will overcome or substantially ameliorate at least some of the deficiencies of the prior art, or to at least provide the public with a useful alternative.

In accordance with a first aspect of the present invention, there is provided a computer-implemented method for generating an authentic video comprising:
receiving a genuine video, the video including an audio track and a visual track,
separating the genuine video into an audio track and a visual track,
embedding a first digital watermark in the visual track,
embedding a second digital watermark in the audio track,
wherein the first digital watermark is based on a first indicator associated with authentic visual data,
wherein the second digital watermark is based on a second indicator associated with authentic audio data.

The method is advantageous because each of the visual track and the audio track are embedded with a separate watermark each. This provides an improved digital watermarking reducing the ability for a person to fake the video. The use of two watermarks is advantageous because it improves robustness against editing and noise. The two separate visual track watermark and audio track watermark are also advantageous because it improves robustness against adversary attacks.

In one example the first indicator is a URL to the authentic visual data and the second indicator is a reference number is linked with the authentic audio data within an audio data repository.

In one example the URL is a hashed URL directed to a website of the authentic visual data. The URL may point to a website that includes a repository of authentic visual data.

In one example the method comprising the steps of:
encrypting the first indicator by using a first security key
encoding the encrypted first indicator to create the first digital watermark, and;
embedding the first digital watermark in the visual track.

In one example the method comprising the steps of:
concatenating the reference number and the first security key to generate a watermark message,
encrypting watermark message using a second security key to create the second digital watermark, and;
embedding the second digital watermark in the audio track.

In one example the method comprising the step of combining the watermarked visual track and the watermarked audio track to generate a digitally watermarked video.

In one example the first indicator is defined as a first 2D scannable code and the second indicator is defined as a second 2D scannable code. In one example, the 2D scannable codes may be a QR code.

In accordance with an aspect of the present invention, there is provided method of validating a video as being an authentic video comprising the steps of:
receiving a video,
separating the video into visual track and audio track,
accessing authentic audio data and authentic visual data,
comparing the audio track from the video with the authentic audio data by applying a matching algorithm,
comparing the visual track from the video with the authentic visual data by applying a matching algorithm,
generating a warning if either of the audio track or the visual track do not match the authentic audio data or authentic visual data respectively, or generating a confirmation validating the video is an authentic video.

The method of validating a method is advantageous because it involves multistage validation of both the audio track and the visual track.

In one example the method comprising the steps of:
accessing authentic audio data from a repository based on a reference number, wherein the reference number is linked to the authentic audio data stored in a repository,
comparing the audio track from the video with the accessed authentic audio data, and;
generating a warning if the audio track from the video does not substantially match the authentic audio data or converting the audio track from the video to text if the audio data substantially matches the authentic audio data.

In one example the method comprising the steps of:
comparing if the text of audio track is present in the authentic audio data i.e., original audio data, and;
generating a warning if the text of the audio track is not present in the authentic audio data or validating the audio track is authentic audio if the text of the audio track is present in the authentic audio data.

In one example the method comprising the steps of:
decrypting a second digital watermark using a second security key to extract a watermark message,
decrypting the watermark message with a first security key to extract a first indicator, and;
using the reference number and the first indicator to access authentic visual data.

In one example the method comprising the steps of:
comparing the visual track of the video with the authentic visual data,
generating a warning if the visual track of the video does not match the authentic visual data, or confirming the visual track of the video is authentic if the visual track from the video matches the authentic visual data, and;
generating a confirmation the video is an authentic video.

In accordance with another aspect of the present invention, there is provided a system for generating an authentic video comprising:
a computing apparatus, the computing apparatus comprising a processor, a memory unit, and a user interface,
the processor operatively coupled to the user interface and the memory unit,
the user interface is configured to receive a genuine video,
the memory unit adapted to store executable instructions which when executed by the processor cause the computing apparatus to:
   receive a genuine video, the video including an audio track and a visual track,
   separate the genuine video into an audio track and a visual track,
   embed a first digital watermark in the visual track,
   embed a second digital watermark in the audio track,
   wherein the first digital watermark is based on a first indicator associated with authentic visual data, and;
   wherein the second digital watermark is based on a second indicator associated with authentic audio data.

In one example the first indicator is a URL to the authentic visual data and the second indicator is a reference number is linked to the authentic audio data within an audio data repository and wherein the URL is a hashed URL directed to a website of the authentic visual data i.e., the original visual data.

In one example the computing apparatus is configured to:
encrypt the first indicator by using a first security key,
encode the encrypted first indicator to create the first digital watermark, and;
embed the first digital watermark in the visual track.

In one example the computing apparatus is configured to:
concatenate the reference number and the first security key to generate a watermark message,
encrypt watermark message using a second security key to create the second digital watermark, and;
embed the second digital watermark in the audio track.

In one example the computing apparatus is configured to combine the watermarked visual track and the watermarked audio track to generate a digitally watermarked video.

In one example the first indicator is defined as a first 2D scannable code and the second indicator is defined as a second 2D scannable code.

In one example the user interface comprises a screen and screen displaying a message
indicating a successful generation of a digitally watermarked video.

In accordance with a further aspect of the present invention there is provided a data processing apparatus comprising a hardware means or a combination of hardware and software means for carrying out at least one of: the method of generating an authentic video according to any one or more of the method statements above or the method of validating a video as being an authentic video according to any one or more method statements above.

In accordance with a further aspect of the present invention, there is provided a computer program comprising instructions which, when the program is executed by a computer, cause the computer to carry out at least one of: the method of generating an authentic video according to any one or more of the method statements above or the method of validating a video as being an authentic video according to any one or more method statements above.

In accordance with a further aspect of the present invention, there is provided a computer-readable medium comprising instructions which, when executed by a computer, cause the computer to carry out at least one of: the method of generating an authentic video according to any one or more of the method statements above or the method of validating a video as being an authentic video according to any one or more method statements above.

In accordance with a further aspect of the present invention there is provided a system for validating a video as being an authentic video comprising:
a computing apparatus, the computing apparatus comprising a processor, a memory unit, and a user interface,
the processor operatively coupled to the user interface and the memory unit,
the user interface is configured to receive a genuine video,
the memory unit adapted to store executable instructions which when executed by the processor cause the computing apparatus to:
   receiving a video,
   separate the video into visual track and audio track, accessing authentic audio data and authentic visual data,
   compare the audio track from the video with the authentic audio data by applying a matching algorithm,
   compare the visual track from the video with the authentic visual data by applying a matching algorithm,
   generate a warning if either of the audio track or the visual track do not match the authentic audio data or authentic visual data respectively, or generating a confirmation validating the video is an authentic video.

In one example the computing apparatus is configured to:
access authentic audio data from a repository based on a reference number, wherein the reference number is linked to the authentic audio data stored in a repository,
Compare the Audio Track From the Video With the Accessed Authentic Audio Data, and;
generate a warning if the audio track from the video does not substantially match the authentic audio data or converting the audio track from the video to text if the audio track substantially matches the authentic audio data.

In one example the computing apparatus is configured to:
compare if the text of audio track is present in the authentic audio data, and;
generate a warning if the text of the audio track is not present in the authentic audio data or validating the audio track is authentic audio if the text of the audio track is present in the authentic audio data.

In one example the computing apparatus is configured to:
decrypting a second digital watermark using a second security key to extract a watermark message,
decrypting the watermark message with a first security key to extract a first indicator,
using the reference number and the first indicator to access authentic visual data,
comparing the visual track of the video with the authentic visual data,
generating a warning if the visual track of the video does not match the authentic visual data, or confirming the visual track of the video is authentic if the visual track from the video matches the authentic visual data, and;
generating a confirmation the video is an authentic video.

The term “comprising” (and its grammatical variations) as used herein are used in the inclusive sense of “having” or “including” and not in the sense of “consisting only of.”

The term “video” (and its grammatical variations) as used herein are used to define a recording, reproduction or broadcast of visual data and audio data. A video includes moving visual data e.g., moving images. A video may include both visual data and audio data. In some instances, a video may include only visual data.

The term “visual track” (and its grammatical variations) refers to the visual components of a video. The term “visual data” may also be used to refer to the visual components or visual information in a video.

The term “audio track” (and its grammatical variations) refers to the audio components of a video. The term “audio data” may also be used to refer to the audio components or audio information in a video.

It is to be understood that, if any prior art information is referred to herein, such reference does not constitute an admission that the information forms a part of the common general knowledge in the art.

### BRIEF DESCRIPTION OF THE DRAWINGS

Embodiments of the present invention will now be described, by way of example, with reference to the accompanying drawings in which:

FIG. 1 illustrates an example of a system for generating an authentic video.

FIG. 2 illustrates a schematic diagram of a computing apparatus that is implemented as the server in the system of FIG. 1.

FIG. 3 illustrates a flow chart for a method of generating an authentic video.

FIG. 4 illustrates a further example flow chart for a method of generating an authentic video.

FIG. 5 illustrates a flow chart for a decoding method for decoding a video that has a digital watermark.

FIG. 6 illustrates a flow chart for a method of validating a video as being an authentic video.

FIG. 7 illustrates an example application of the validation process result as applied to an example video clip.

### DETAILED DESCRIPTION OF THE PREFERRED EMBODIMENTS

The present invention relates to a system and method for generating an authentic video by applying a digital watermark. The present invention a validation process to validate a video is authentic based on an applied digital watermark. The present invention relates to authentication of genuine video clips based on digital watermarking, which allow an input video to be validated only if both the audio track and the video track are authentic. Each of the video track and the audio track are embedded with a watermark.

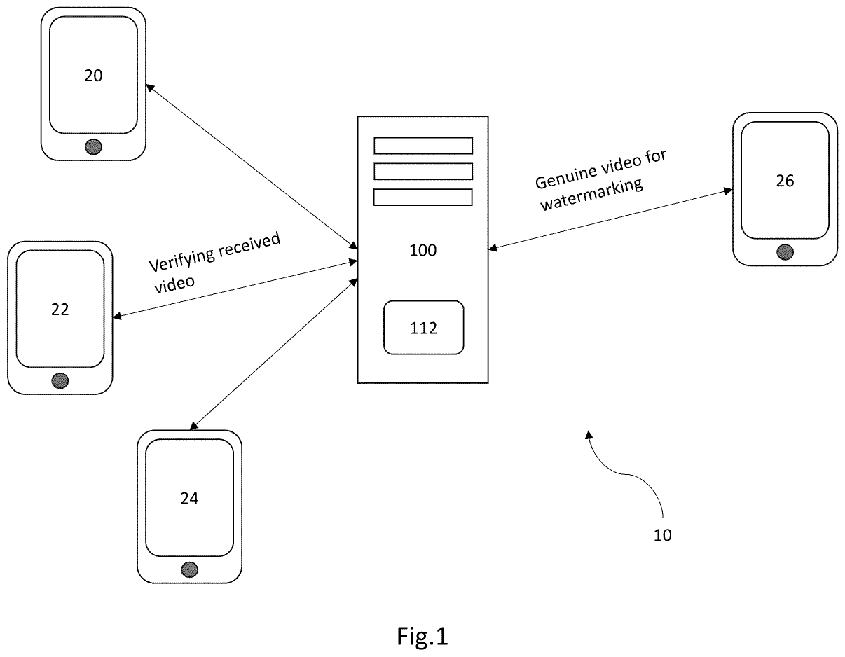

Referring to FIG. 1, an embodiment of the present invention is illustrated. This embodiment is arranged to provide a system 10 for generating an authentic video comprising: an authentic video server 100, public user devices 20, 22, 24, 26. The public user devices 20-26 are configured to communicate with the video server 100. The authentic video server 100 and the public user devices 20-26 are arranged in a server client relationship. The public user devices 20-26 may function as client devices. Each of the public user can access and communicate with the authentic video server 100 via an app installed on their respective device. In one example the public user device may be a smartphone or tablet or smartwatch or any other internet capable device.

Any user may send a request to authenticate a video to the authentic video server 100. The request may be a digital request via an app. The request may be a digital message provided to server 100.

The server 100 may be a computing apparatus. The server (i.e., the computing apparatus 100) comprising a processor 102, a memory unit 104, 106 and a user interface 112. The processor 102 operatively coupled to the user interface 112 and the memory unit 104, 106. The user interface 112 is configured to receive a genuine video. The genuine video may be verified by a user. The memory unit 104, 106 is adapted to store executable instructions which when executed by the processor 102 cause the computing apparatus to: receive a genuine video, the video including an audio track and a visual track, separate the genuine video into an audio track and a visual track, embed a first digital watermark in the visual track, embed a second digital watermark in the audio track, wherein the first digital watermark is based on a first indicator associated with authentic visual data, and; wherein the second digital watermark is based on a second indicator associated with authentic audio data.

The computing apparatus 100 is adapted to execute an encoding process i.e., a method of generating an authentic video. The encoding process is configured to embed a digital watermark into the genuine video in order to generate an authentic video. The authentic video can be validated as an authentic video.

A public user 20-26 may further be configured to receive a video from any source e.g., another public user. The public user may require validation that the received video is an authentic video. The user may send a validation request, via a user device 20-26, to the authentic video server 100. The server 100 may further be configured to execute a validation process 300 in response to the validation request. The validation request may confirm the received video is a genuine video or may provide an indication that the video is a fake or not a genuine video.

In this example embodiment, authentic video server 100 may be implemented by a computing apparatus having an appropriate user interface. The computing apparatus 100 may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing apparatus 100 may be appropriately programmed to implement a method for generating an authentic video 200. The computing apparatus 100 may also be programmed to implement a method for validating a genuine video 300.

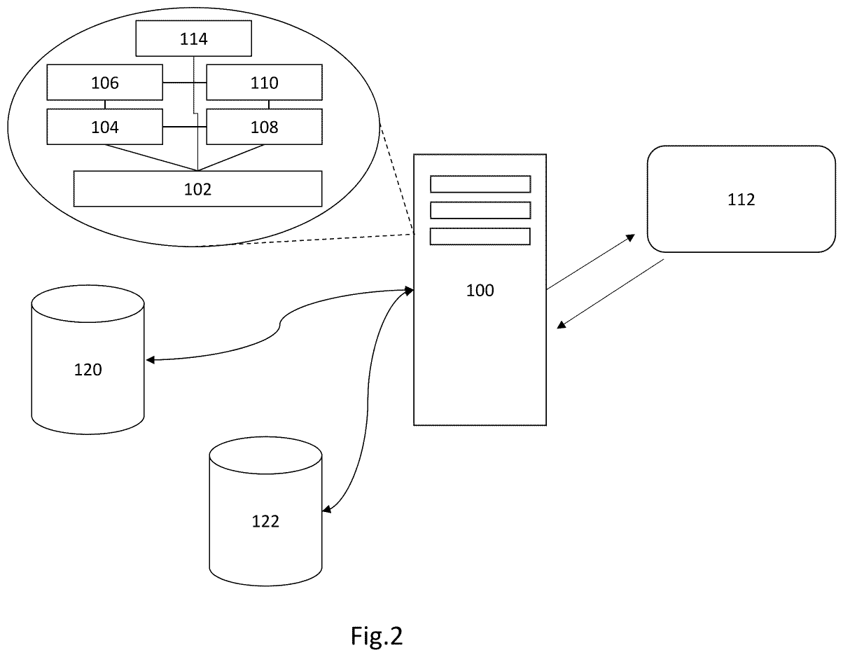

As shown in FIG. 2 there is a shown a schematic diagram of a computing apparatus 100 (i.e., computer or computing device or computing system) which is arranged to be implemented as an example embodiment of a system for generating an authentic video 10. In this embodiment the server 100 (i.e., computing apparatus) includes suitable components necessary to receive, store and execute appropriate computer instructions. The components may include a processor 102 (i.e., processing unit), including Central Processing Unit (CPU), Math Co-Processing Unit (Math Processor), Graphic Processing Unit (GPUs) or Tensor processing unit (TPUs) for tensor or multi-dimensional array calculations or manipulation operations. The computing apparatus 100 further comprises a read-only memory (ROM) 104, random access memory (RAM) 106, and input/output devices such as disk drives 108, input devices 110 such as an Ethernet port, a USB port, etc.

The computing apparatus 100 may further comprise a user interface 112. In the illustrated example, the user interface may be a display 112. Display 112 may be a suitable display such as a liquid crystal display, a light emitting display or any other suitable display. The user interface 112 may be a gateway e.g., a data gateway that is configured to receive requests or commands from the user devices 20-26. The server 100 (i.e., computing apparatus 100) may include instructions that may be included in ROM 104, RAM 106 or disk drives 108 and may be executed by the processor 102.

The computing apparatus 100 may further comprise a plurality of communication links 114 which may variously connect to one or more computing devices such as a server, personal computers, terminals, wireless or handheld computing devices, Internet of Things (IoT) devices, smart devices, edge computing devices. For example, the communications links 114 allow the server 100 to communicate with the user devices 20-26 via a communication network such as a cellular network or the internet or any other wireless communication network. At least one of a plurality of communications link may be connected to an external computing network through a telephone line or other type of communications link.

The server 100 may include storage devices such as a disk drive 108 which may encompass solid state drives, hard disk drives, optical drives, magnetic tape drives or remote or cloud-based storage devices. The server 100 may use a single disk drive or multiple disk drives, or a remote storage service. The server 100 may also have a suitable operating system which resides on the disk drive or in the ROM of the server 100.

The computing apparatus 100 (i.e., server 100) may further comprise one or more databases adapted to store one or more pieces of data. Optionally, the server 100 may include at least one audio database 120 that may store genuine audio data. Optionally, the server 100 may further include at least one video database 122 that may store genuine video data. The audio database and video database may function as repositories.

The computing apparatus 100 may also provide the necessary computational capabilities to operate or to interface with a machine learning network, such as a neural networks, to provide various functions and outputs. The neural network may be implemented locally, or it may also be accessible or partially accessible via a ML server or cloud-based service. The machine learning network may also be untrained, partially trained or fully trained, and/or may also be retrained, adapted or updated over time. The computing apparatus may comprise one or more GPUs being operatively coupled to the CPU (i.e., processor). The computing apparatus may comprise additional hardware elements operatively coupled to the CPU and/or the GPU to provide the computing apparatus components needed to implement a machine learning network or machine learning model. The learning network or model may be stored in a memory unit e.g., ROM.

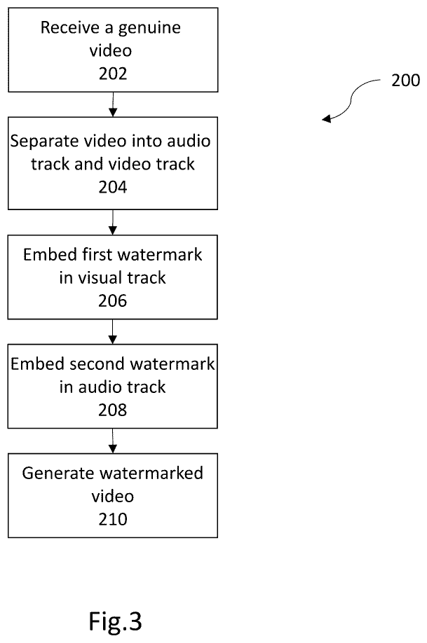

FIG. 3 illustrates a flow chart of a method of generating an authentic video 200. The method 200 may be executed by the authentic video server 100. The steps of method 200 may be embodied as computer readable and executable instructions. The instructions may be executed by the processor 102 of the computing apparatus 100 (i.e., the server 100).

Referring to FIG. 3, the method commences at step 202. Step 202 comprises receiving a genuine video, the video including an audio track and a visual track, Step 204 comprises separating the genuine video into an audio track and a visual track. Step 206 comprises embedding a first digital watermark in the visual track. Step 208 comprises embedding a second digital watermark in the audio track. The first digital watermark is based on a first indicator associated with authentic visual data and the second digital watermark is based on a second indicator associated with authentic audio data. Step 210 comprises combining the watermarked visual track and audio track to generate a watermarked video.

In one example the first indicator is a URL to the authentic visual data and the second indicator is a reference number is linked with the authentic audio data within an audio data repository. In one example the URL is a hashed URL directed to a website of the authentic visual data. The URL may point to a website that includes a repository of authentic visual data. The URL may point to a repository such as a database. The server 100 may be configured to generate the hashed URL.

The method 200 is advantageous because each of the visual track and the audio track are embedded with a separate watermark each. This provides an improved digital watermarking reducing the ability for a person to fake the video. The use of two watermarks is advantageous because it improves robustness against editing and noise. The two separate visual track watermark and audio track watermark are also advantageous because it improves robustness against adversary attacks.

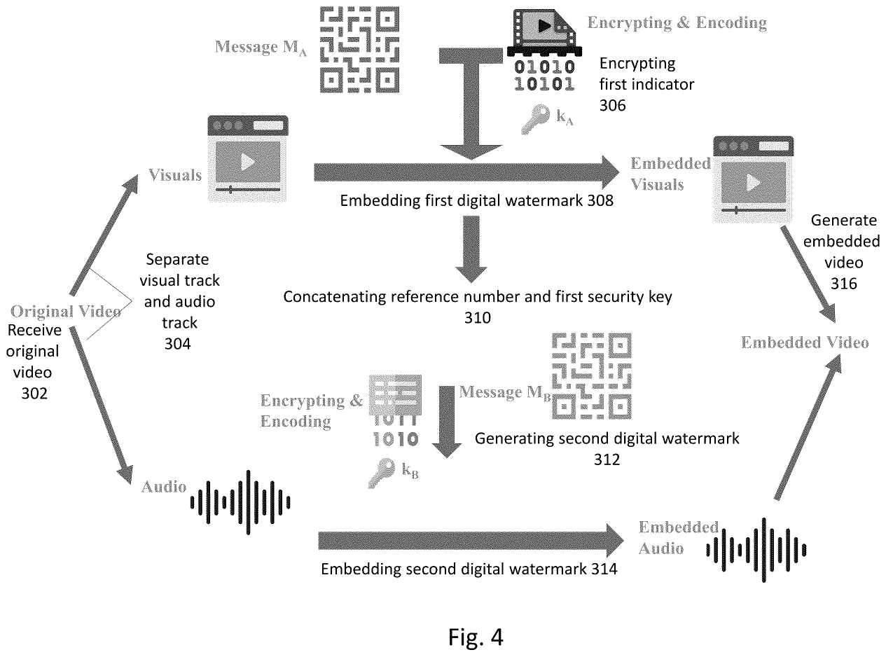

FIG. 4 illustrates a further example method 300 of generating an authentic video by adding one or more digital watermarks to a genuine video. FIG. 3 illustrates an encoding method to generate an authentic video by applying separate digital watermarks to the audio track and visual track of a video.

Referring to FIG. 4, the method 300 commences at step 302. Step 302 comprises receiving a genuine video e.g., from a public user of the system 10. Step 304 comprises separating the original video into a visual track and an audio track. Step 306 comprises encrypting a first indicator by using a first security key.

As shown in FIG. 4, the first indicator M_{A} may be encrypted by the first security key kₐ. A first digital watermark is created by encoding the encrypted message M_{A.} In one example the first indicator may be a 2D scannable code e.g., a QR code. The first indicator may include an address to a repository storing authentic or genuine visual data. The message M_{A} may be a URL, in particular a hashed URL. The hashed URL may be encoded in a QR code.

Step 308 comprises embedding the first digital watermark into the visual track. Step 310 comprises concatenating a reference number and the first security key to generate a watermark message. In one example the reference number i.e., the second indicator is a reference number is linked to the authentic audio data within an audio data repository. In this example, a reference number A may be concatenated with the key k_{A} to generate a watermark message M_{B}. The watermark message may be encoded into a scannable code e.g., a QR code.

Step 312 comprises encrypting the watermark message using a second security key k_{B} to create the second digital watermark. Step 314 comprises embedding the second digital mark in the audio track. Step 316 comprises combining the embedded visual track and embedded audio track to generate an embedded video. The method 300 may be executed by the server 100.

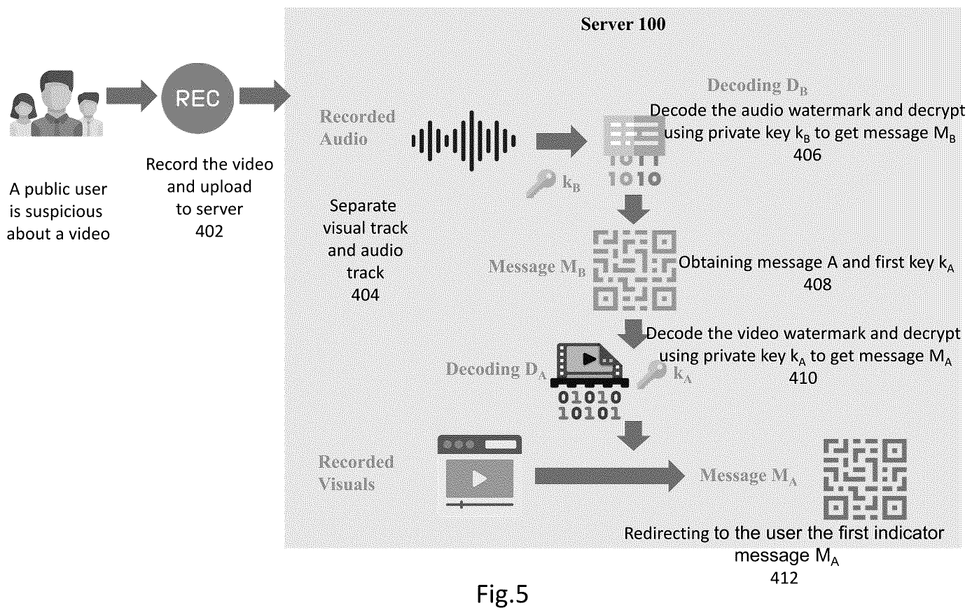

FIG. 5 illustrates a decoding method 400 for decoding a video that has a digital watermark. A public user may not have trust in a received video. A public user may want to determine the authenticity of a video. Determining authenticity may include two stages decoding a video and a validating the video. At step 402 a public user may record the video of concern and upload the video the server 100. Step 404 comprises separating the received video into a visual track and an audio track. Step 406 comprises decoding the audio watermark (i.e., a second watermark) and decrypting the audio watermark using a private key k_{B} to obtain a second indicator e.g., message M_{B}.

Step 408 comprises obtaining a reference number A and first key k_{A} from the decoded audio watermark, specifically from decoding message M_{B}. Step 410 comprises decoding the video watermark i.e., the first watermark in the visual track, and decrypting the watermark using a first private key k_{A} to obtain a first indicator i.e., a first message M_{A}. Step 412 comprises redirecting to the user the first indicator i.e., the URL in message M_{A.} The user can validate the message using a validation process 500.

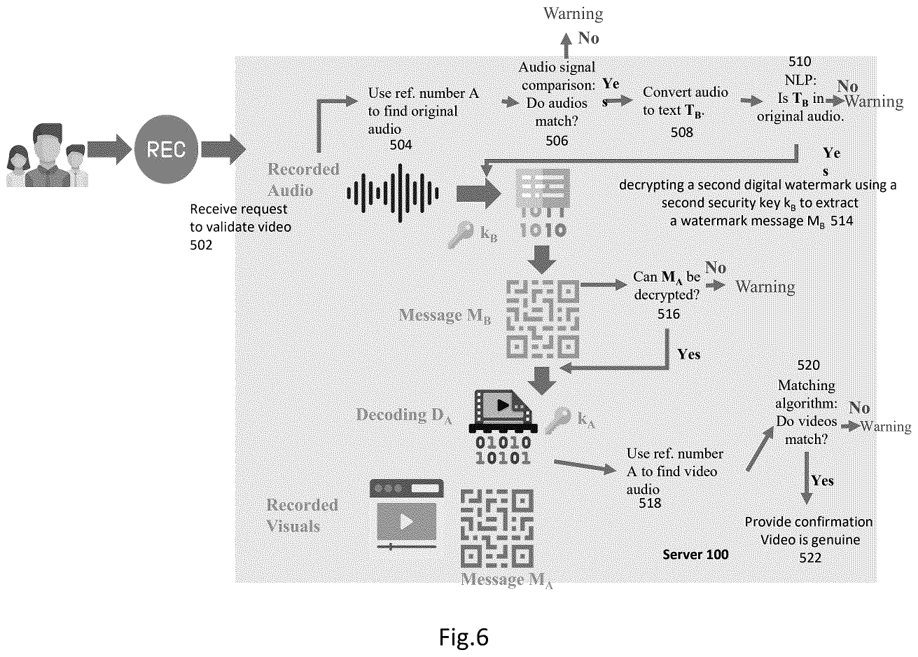

FIG. 6 illustrates a method 500 of validating a video as being an authentic video. The validation method 500 may be performed after the decoding process 400. Alternatively, the validation process 500 may be performed independently in response to a validation request from a user. The method 500 commences at step 502. Step 502 comprises receiving a video and request to validate the authenticity of the video. The video may be separated into the visual track and the audio track. Step 504 comprises accessing authentic audio data by using a reference number A. Step 506 comprises comparing the audio track with the authentic audio data i.e., the original audio data. If NO, then a warning is generated. The warning may be sent to the user device or may be displayed on a user interface 112. If YES at step 506, the method moves to step 508.

Step 508 comprises converting the audio track to text. The audio to text conversion may be performed by the server 100 by applying a sound to text T_{B} i.e., an audio to text algorithm. Step 510 comprises performing natural language processing (NLP). Step 512 comprises checking if the text T_{B} is present in the authentic audio data i.e., the original audio. A speech validation process may be performed at step 512. If the text is not present in the authentic audio data, then a warning is generated. If the text matches the authentic audio data, the method proceeds to step 514. The method of validation involves two checks of the audio track of the video with the authentic audio data. For example, a subtle speech change of “will support” becoming “will not support” in a fake video clip can be detected by comparing the text with the authentic audio. This two step check and checking text provides a more robust identification of fake videos.

Step 514 comprises decrypting a second digital watermark using a second security key k_{B} to extract a watermark message M_{B}. Step 516 comprises checking if the first indicator i.e., message M_{A} be decrypted. If NO, then a warning is generated. If YES at step 516 then the watermark message is decrypted using a first security key k_{A} to extract a first indicator e.g., message M_{A}.

Step 518 comprises using the reference number e.g., number A and the first indicator to access the authentic visual data. Step 520 comprises comparing the visual track of the video with the authentic video data. A warning is generated if the visual track does not match the authentic video data i.e., if the check at step 520 is a NO. If the visual track and the authentic video match i.e., YES. Step 522 comprises generating a confirmation the video is an authentic video.

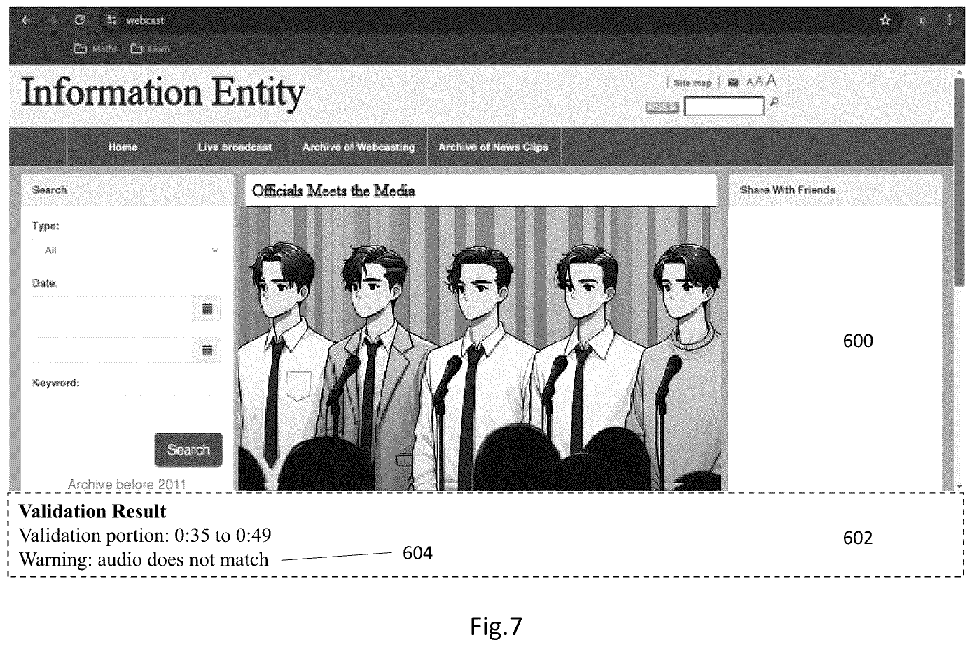

FIG. 7 illustrates an example application of the validation process result. A video 600 is illustrated. The video between 0.35s to 0.49s were assessed for authenticity as shown in the message portion 602. A warning message 604 is shown indicating that the audio does not match. The audio for at least between 0.35s to 0.49s does not match. Optionally, the user may be redirected to the original video i.e., the authentic video.

The system 10 will only validate a video as an authentic video if both the audio track and visual track are confirmed as being authentic based on the digital watermarks. If the audio does not match an alarm is raised. If the video does not match an alarm is raised. Additionally, if the audio text does not match a warning is raised.

The method 500 may be executed by the system 10. The system for generating an authentic video as described may also be used to validate a received video as being an authentic video or as being a modified or fake video. In particular the method 500 may be executed by the server 100. The method 400 may also be performed by the server 100. The method 500 and method 400 may be embodied as computer readable and executable instructions that may be stored in a memory unit and executed by the processor 102 of the server 100.

The system and method for generating an authentic video with digital watermarking is advantageous because two digital watermarks are used. The audio track and visual track are separately embedded with digital watermarks. The watermarks are generated based on an indicator to the authentic or original audio data and visual data, respectively. The two watermarks used improves robustness against editing of videos and noise. The watermarks used improve robustness against adversary attacks. An adversary has to attack and manipulate two separate digital watermarks. Additionally, the validation approach identifies two separate watermarks and compares the received audio track and visual track against the respective authentic audio data and visual data to verify any errors. This improves the identification of fakes. The described system and method improve the quality of the watermarked video. Additionally, quality is improved by watermarking in the DT-CWT domain.

The system and method for generating an authentic video is advantageous because it provides a robust and secure generation of an authentic video that is more resistant to fakes as compared to using a single digital watermark.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described above may be operable or implemented on any type of specific-purpose or special computer, or any machine or computer or server or electronic device with a microprocessor, processor, microcontroller, programmable controller, or the like, or a cloud-based platform or other network of processors and/or servers, whether local or remote, or any combination of such devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the above description, a storage medium may represent one or more devices for storing data, including read-only memory (ROM), random access memory (RAM), magnetic disk storage mediums, optical storage mediums, flash memory devices and/or other machine or computer readable mediums for storing information.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the scope of the invention. Additional elements or components may also be added without departing from the scope of the invention. Additionally, the features described herein may be implemented in software, hardware, as a business method, and/or combination thereof.

In its various aspects, embodiments of the invention can be embodied in a computer-implemented process, a machine (such as an electronic device, or a general-purpose computer or other device that provides a platform on which computer programs can be executed), processes performed by these machines, or an article of manufacture.

1. A computer-implemented method for generating an authentic video comprising:
receiving a genuine video, the video including an audio track and a visual track,
separating the genuine video into an audio track and a visual track,
embedding a first digital watermark in the visual track,
embedding a second digital watermark in the audio track,
wherein the first digital watermark is based on a first indicator associated with authentic visual data,
wherein the second digital watermark is based on a second indicator associated with authentic audio data.

2. The method of claim 1, wherein the first indicator is a URL to the authentic visual data and the second indicator is a reference number is linked with the authentic audio data within an audio data repository.

3. The method of claim 2, wherein the URL is a hashed URL directed to a website of the authentic visual data.

4. The method of claim 2, comprising the steps of:
encrypting the first indicator by using a first security key
encoding the encrypted first indicator to create the first digital watermark, and;
embedding the first digital watermark in the visual track.

5. The method of claim 4, comprising the steps of:
concatenating the reference number and the first security key to generate a watermark message,
encrypting watermark message using a second security key to create the second digital watermark, and;
embedding the second digital watermark in the audio track.

6. The method of claim 5, comprising the step of combining the watermarked visual track and the watermarked audio track to generate a digitally watermarked video.

7. The method of claim 6, wherein the first indicator is defined as a first 2D scannable code and the second indicator is defined as a second 2D scannable code.

8. A method of validating a video as being an authentic video comprising the steps of:
receiving a video,
separating the video into visual track and audio track,
accessing authentic audio data and authentic visual data,
comparing the audio track from the video with the authentic audio data by applying a matching algorithm,
comparing the visual track from the video with the authentic visual data by applying a matching algorithm, and;
generating a warning if either of the audio track or the visual track do not match the authentic audio data or authentic visual data respectively, or generating a confirmation validating the video is an authentic video.

9. The method of claim 8 comprising the steps of:
accessing authentic audio data from a repository based on a reference number, wherein the reference number is linked to the authentic audio data stored in a repository,
comparing the audio track from the video with the accessed authentic audio data, and;
generating a warning if the audio track from the video does not substantially match the authentic audio data or converting the audio track from the video to text if the audio track substantially matches the authentic audio data.

10. The method of claim 9 comprising the steps of:
comparing if the text of audio track is present in the authentic audio data or authentic audio data, and;
generating a warning if the text of the audio track is not present in the authentic audio data or authentic audio data, or, validating the audio track is authentic audio if the text of the audio track is present in the authentic audio data or in the authentic audio data.

11. The method of claim 10 comprising the steps of:
decrypting a second digital watermark using a second security key to extract a watermark message,
decrypting the watermark message with a first security key to extract a first indicator, and;
using the reference number and the first indicator to access authentic visual data.

12. The method of claim 11 comprising the steps of:
comparing the visual track of the video with the authentic visual data,
generating a warning if the visual track of the video does not match the authentic visual data, or confirming the visual track of the video is authentic if the visual track from the video matches the authentic visual data, and;
generating a confirmation the video is an authentic video.

13. A system for generating an authentic video comprising:
a computing apparatus, the computing apparatus comprising a processor, a memory unit, and a user interface,
the processor operatively coupled to the user interface and the memory unit,
the user interface is configured to receive a genuine video,
the memory unit adapted to store executable instructions which when executed by the processor cause the computing apparatus to:
receive a genuine video, the video including an audio track and a visual track,
separate the genuine video into an audio track and a visual track,
embed a first digital watermark in the visual track,
embed a second digital watermark in the audio track,
wherein the first digital watermark is based on a first indicator associated with authentic visual data, and;
wherein the second digital watermark is based on a second indicator associated with authentic audio data.

14. The system of claim 13, wherein the first indicator is a URL to the authentic visual data and the second indicator is a reference number is linked to the authentic audio data within an audio data repository and wherein the URL is a hashed URL directed to a website of the authentic visual data.

15. The system of claim 14, wherein the computing apparatus is configured to:
encrypt the first indicator by using a first security key,
encode the encrypted first indicator to create the first digital watermark, and;
embed the first digital watermark in the visual track.

16. The system of claim 13, wherein the computing apparatus is configured to:
concatenate the reference number and the first security key to generate a watermark message,
encrypt watermark message using a second security key to create the second digital watermark, and;
embed the second digital watermark in the audio track.

17. The system of claim 16, wherein the computing apparatus is configured to combine the watermarked visual track and the watermarked audio track to generate a digitally watermarked video.

18. The system of claim 17, wherein the first indicator is defined as a first 2D scannable code and the second indicator is defined as a second 2D scannable code.

19. The system of claim 17, wherein the user interface comprises a screen and screen displaying a message indicating a successful generation of a digitally watermarked video.
